(19) United States
(12) Patent Application Publication
(10) Pub. No.: US 2006/0125850 A1
(43) Pub. Date: Jun. 15, 2006

(54) Method of compensating missing nozzle and printer using the same

(76) Inventors: Tae-Kyun Kim, Yongin-si (KR); Myung-Song Jung, Gunpo-si (KR)

Correspondence Address: STANZIONE & KIM, LLP, 919 18TH STREET, N.W., SUITE 440, WASHINGTON, DC, 20006, US

(21) Appl. No.: 11/272,138

(22) Filed: Nov. 14, 2005

(30) Foreign Application Priority Data
Dec. 14, 2004 (KR) 2004-105908

(51) Int. Cl. B41J 29/38

(52) U.S. Cl. 347/5; 347/17

(57) ABSTRACT

A method of compensating a missing nozzle of a printer and a printer using the same. The method includes determining adjacent nozzles corresponding to the missing nozzle, and compensating the missing nozzle by generating dots having an increased size through the adjacent nozzles and generating dots having a normal size through other nozzles when the missing nozzle is generated in the nozzles performing a printing operation. Therefore, it is possible to compensate operations of all color nozzles as well as the black nozzle. As a result, the method of compensating the missing nozzle of the printer compensates operations of the missing nozzle when an image having a composite color is printed as well as when the black image is printed. In addition, it is possible to maintain appropriate image quality by compensating the operation of the missing nozzle through other adjacent nozzles even when a portion of the adjacent nozzles is out of order, since the number of the adjacent nozzles is larger.

### CROSS-REFERENCE TO RELATED APPLICATIONS

This application claims the benefit under 35 U.S.C. §119 of Korean Patent Application No. 2004-105908, filed Dec. 14, 2004, the disclosure of which is hereby incorporated herein by reference in its entirety.

### BACKGROUND OF THE INVENTION

1. Field of the Invention

The present general inventive concept relates to an inkjet printer, and more particularly, to a method of compensating a missing nozzle, and a printer using the same to maintain an appropriate image quality by compensating an operation of the missing nozzle through adjacent nozzles.

2. Description of the Related Art

An inkjet printer is generally classified into a shuttle (or serial) printer and a page printer based on a method driving a printer head. The shuttle printer prints an image as the printer head laterally moves, and the page printer prints an image with the printer head being fixed in a lateral direction to media.

In the case of the shuttle printer, when a missing nozzle is generated, an image corresponding to the missing nozzle may be compensated through adjacent nozzles using a shingling method, that is, by laterally reciprocating a printer head carriage several times.

However, in case of the page printer, when the missing nozzle is generated, it is impossible to compensate the image corresponding to the missing nozzle using the shingling method like the shuttle printer, since the printer head is stationary. That is, since one nozzle should print a certain region during a predetermined period, when the missing nozzle exists in the head, a region where the printing is not performed, i.e., a white line, is created to deteriorate image quality.

U.S. Pat. No. 5,581,284 discloses a method for compensating a missing nozzle when the missing nozzle abnormally ejects ink in a page printer.

FIGS. 1A-1D show a method for compensating the missing nozzle when the missing nozzle is generated to form a region 63 where printing is not performed while normal nozzles 61 eject color ink K on a sheet of paper 18 moving in a direction 62. A cyan nozzle, a magenta nozzle and a yellow nozzle corresponding to the region 63 are obtained as shown in FIGS. 1B-1D ink C is ejected to the region 63 through the obtained cyan nozzle in FIG. 1B magenta ink M is ejected to region 63 through the obtained magenta nozzle in FIG. 1C and, yellow ink P is ejected to region 63 through the obtained yellow nozzle in FIG. 1D.

As a result, in the region 63 black dots are generated by combination of cyan, magenta and yellow to compensate operations of the missing nozzle as shown in FIG. 1A. The black color of the dots on the paper 18 is generally referred to as a process black or a composite black.

However, since the method forms the black color through the combination of three colors (cyan, magenta and yellow), to compensate only the black missing nozzle, it is impossible to compensate missing nozzles of other colors.

In addition, in the case that the cyan, magenta and yellow nozzles corresponding to the black missing nozzle are already operated when the black missing nozzle should be compensated, or any one of the cyan, magenta and yellow nozzles is out of order, it is impossible to compensate the black missing nozzle.

For example, when a black image is printed, since the cyan, magenta and yellow nozzles corresponding to the black missing nozzle are not operated, it is possible to compensate the black missing nozzle using these nozzles. However, when the composite color image is printed, since the cyan, magenta and yellow nozzles are likely to be operated, when any one of the nozzles is operated, it is impossible to generate black dots corresponding to the black missing nozzle.

### SUMMARY OF THE INVENTION

In order to solve the foregoing and/or other problems, the present general inventive concept provides a method of compensating a missing nozzle of a printer, and a printer using the same so that an appropriate image quality can be maintained by compensating a region, at which the missing nozzle should print, using at least one nozzle adjacent to the missing nozzle.

The present general inventive concept provides a method of compensating a missing nozzle of a printer, and a printer using the same to compensate operations of missing nozzles corresponding to all colors.

Additional aspect and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of compensating a missing nozzle of a printer including determining adjacent nozzles corresponding to the missing nozzle, and the method compensating the missing nozzle by generating dots having an increased size through the adjacent nozzles and generating dots having a normal size through other normal nozzles when the missing nozzle is generated in the nozzles performing an printing operation.

The compensating of the missing nozzle may include applying a first drive signal for ejecting the ink to the other normal nozzles, applying a second drive signal for preheating and ejecting the ink to the adjacent nozzles The adjacent nozzles eject the ink, after preheating the ink, depending on the second drive signal and the other normal nozzles eject the ink, depending on the first drive signal using the other normal nozzles.

The foregoing and/or other aspects and advantages of the present general inventive concept may also be achieved by providing a printer including a controller to apply a preheating signal and an ejection signal to adjacent nozzles corresponding to a missing nozzle and, to apply only the ejection signal to other nozzles, when the missing nozzle is generated in the nozzles performing a print operation a memory to store information on the missing nozzle and the adjacent nozzles corresponding to the missing nozzle, and a plurality of nozzle arrays having one or more nozzles and one or more nozzle heaters to eject ink through at least one of the nozzles after preheating the ink when the nozzle heater receives the preheating signal and the ejecting signal, and to eject the ink through at least one of the nozzles, without preheating the ink when the nozzle heater receives only the ejecting signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A-1D are views illustrating a conventional method of compensating a missing nozzle of a printer;

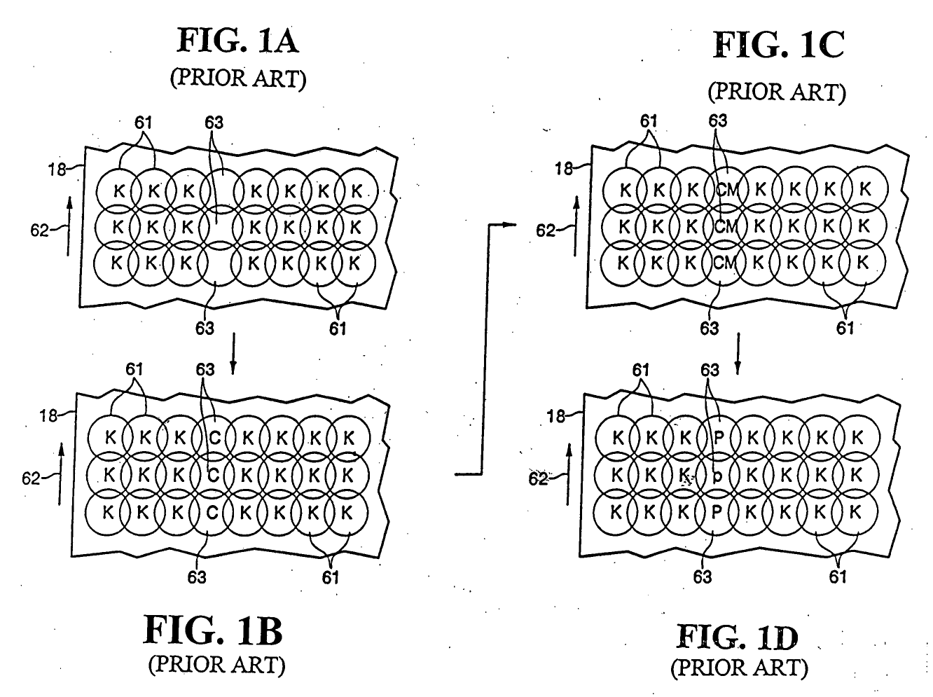

FIG. 2 is a view illustrating an inner block diagram of a printer according to an embodiment of the present general inventive concept;

FIGS. 3A and 3B are views illustrating a relationship between viscosity and a dot size, respectively;

FIG. 4 is a flow chart illustrating a method of compensating a missing nozzle of a printer according to an embodiment of the present general inventive concept;

FIGS. 5A-5E are views illustrating an ejecting signal and a preheating signal of a printer according to an embodiment of the present general inventive concept;

FIGS. 6A and 6B are views illustrating a relationship between a temperature of a heater and a temperature of ink;

FIGS. 7A-7C are views illustrating dots generated depending on adjacent nozzles and a method of compensating a missing nozzle using the same according to an embodiment of the present general inventive concept;

FIGS. 8A-8C are views illustrating dots generated depending on adjacent nozzles and a method of compensating a missing nozzle using the same according to an embodiment of the present general inventive concept; and

FIG. 9 is a view illustrating dots generated depending on adjacent nozzles and a method of compensating a missing nozzle using the same according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

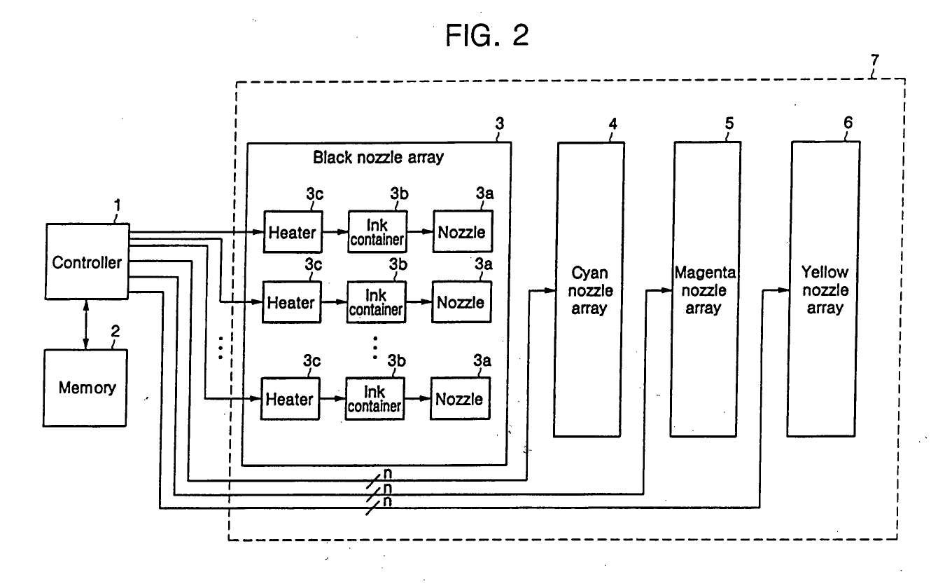

FIG. 2 is a view illustrating an inner block diagram of a printer according to an embodiment of the present general inventive concept.

Referring to FIG. 2, the printer includes a controller 1, a memory 2, and a printer head 7, and the printer head 7 includes a plurality of nozzle arrays 3, 4, 5 and 6 corresponding to black, cyan, magenta and yellow, respectively. Each of the nozzle arrays 3, 4, 5 and 6, for example, the black nozzle array 3 includes a plurality of nozzles 3a, a plurality of heaters 3c corresponding to the respective nozzles 3a, and a plurality of ink containers 3b corresponding to the respective nozzles 3a.

The controller 1 discriminates whether a missing nozzle is generated, for example, in the nozzles 3a while performing a printing operation, when an operation of a printer is requested. The printer generates normal dots through the nozzles 3a and determines whether there is a missing dot according to a malfunction of the nozzle. When the missing nozzle is included, the controller 1 makes adjacent nozzles of normal nozzles, located in the same row, laterally adjacent to the missing nozzle or a combination of two rows of normal nozzles, corresponding to the missing nozzle generate one or more dots having an increased size, by applying a second drive signal, and makes other normal nozzles generate dots having a normal size through other normal nozzles by applying a first drive signal. The increased size dots of the adjacent nozzles' ink are printed on a location where the missing nozzle's dot would otherwise be.

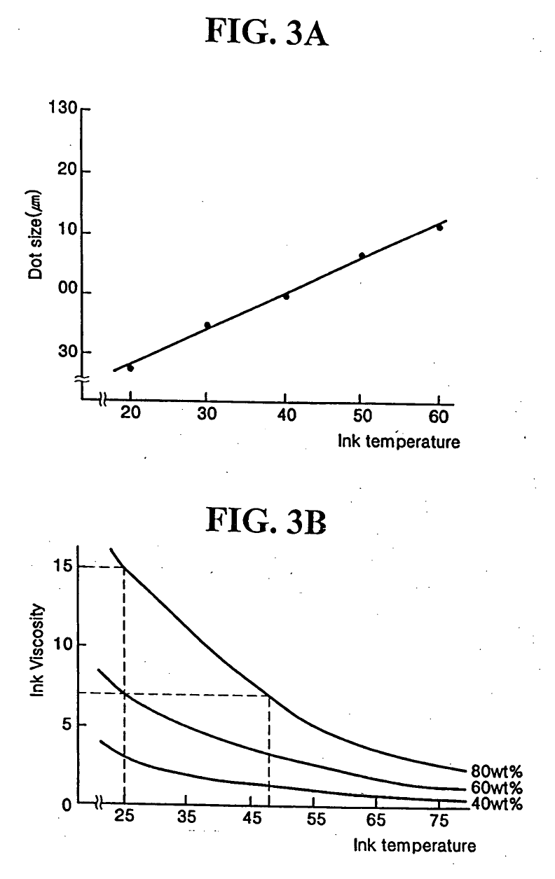

The size of dots at this time is increased in proportion to temperature of the ink, as shown in FIG. 3A. That is, when the temperature of the ink is increased, viscosity of the ink is decreased as shown in to FIG. 3B increase a weight of the ink ejected through the same nozzle. As a result, the size of the dots is also increased depending on the increased ink weight.

Therefore, the controller 1 applies the first drive signal including only an ejecting signal to the respective heaters 3c of the normal nozzles, and applies the second drive signal including a preheating signal and the ejecting signal to the respective heaters 3c of the adjacent nozzles.

The ejecting signal has energy for ejecting the ink, and the preheating signal has energy for increasing the temperature of the ink.

Then, the controller 1 further includes a function performing self-verification to update information on the missing nozzle and the adjacent nozzles corresponding to the missing nozzle. For this, the controller 1 prints a test pattern or a test page designed to confirm the missing nozzle through the nozzle array 3, scans the pattern or page to discriminate whether the missing dot is generated, and then obtains the missing nozzle corresponding to the missing dot and adjacent nozzles adjacent to the missing nozzle when the missing dots are generated.

The memory 2 stores the information on the missing nozzle and the adjacent nozzles corresponding to the missing nozzle. The information on the missing nozzle and the adjacent nozzles may be stored by the controller 1 or a product manufacturer during a product manufacturing process.

The nozzle arrays 3, 4, 5 and 6 perform the printing operation, varying the dot size generated by the adjacent nozzles under the control of the controller 1. More specifically, when signal and the ejecting signal from the controller 1, the heater 3c preheats the ink in container 3b, and then heats one more time in order to eject the ink. On the other hand, when the heater 3c receives the first drive signal including only the ejecting signal from the controller 1, the heater 3c heats to eject the ink without preheating the ink. Then, the ink is heated once by the heater 3c at the ink container 3b and ejected through the nozzle 3a.

Hereinafter, a method of compensating a missing nozzle of a printer according to an embodiment of the present general inventive concept will be described.

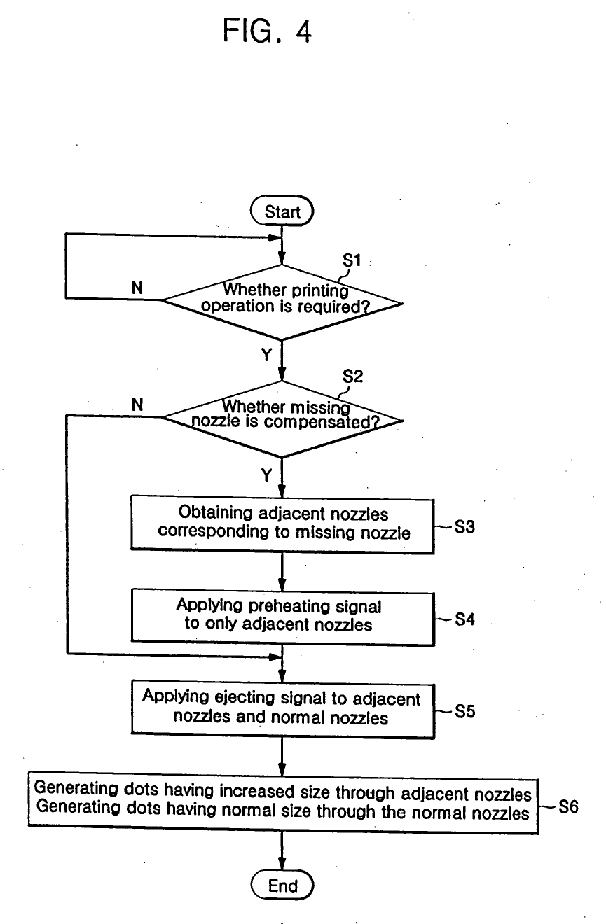

FIG. 4 is a flow chart illustrating a method of compensating a missing nozzle of a printer according to the present general inventive concept.

Referring to FIGS. 2 and 4, when a printing operation is required (operation S1), the controller 1 obtains information of nozzles to perform the printing operation, and compares the obtained information with information of a missing nozzle stored in the memory 2 to discriminate whether the missing nozzle is compensated (operation S2).

As a result of the discrimination in operation S2, when the missing nozzle is included in the nozzles performing the printing operation, the controller 1 reads the memory 2 to obtain adjacent nozzles corresponding to the missing nozzle and set other nozzles except for the adjacent nozzles to normal nozzles (operation S3).

Then, the controller 1 generates a preheating signal and applies the preheating signal to the respective heaters 3c corresponding to the adjacent nozzles obtained in operation S3 (operation S4).

After a predetermined period is elapsed, the controller 1 generates an ejecting signal and applies the ejecting signal to the respective heaters, such as 3c, corresponding to the adjacent nozzles and the normal nozzles (operation S5).

The adjacent nozzles corresponding to the heaters 3c receiving the second drive signal, including the preheating signal and the ejecting signal through operations S4 and S5, generate dots having an increased size, while the normal nozzles corresponding to the heaters 3creceiving the first drive signal, including only the ejecting signal through operation S5, generate dots having a normal size in operation (S6).

That is, in operation S6, the respective heaters 3c of the adjacent nozzles first preheat the ink according to the preheating signal and heat the preheated ink one more time according to the ejecting signal. As a result, the preheated ink is ejected through the adjacent nozzles according to the ejecting signal to generate the dots having the increased size.

On the other hand, the respective heaters 3c of the normal nozzles heat the ink according to the ejecting signal without preheating the ink. As a result, the dots having the normal size are generated through the normal nozzles.

As described above, the method of compensating the missing nozzle of the printer in accordance with the present invention additionally applies the preheating signal to the heaters of the adjacent nozzles to allow the dots generated through the adjacent nozzles to have an increased size when operations of the inferior nozzle are detected. Therefore, a missing dot region generated by the missing nozzle can be compensated through the adjacent dots having an increased size.

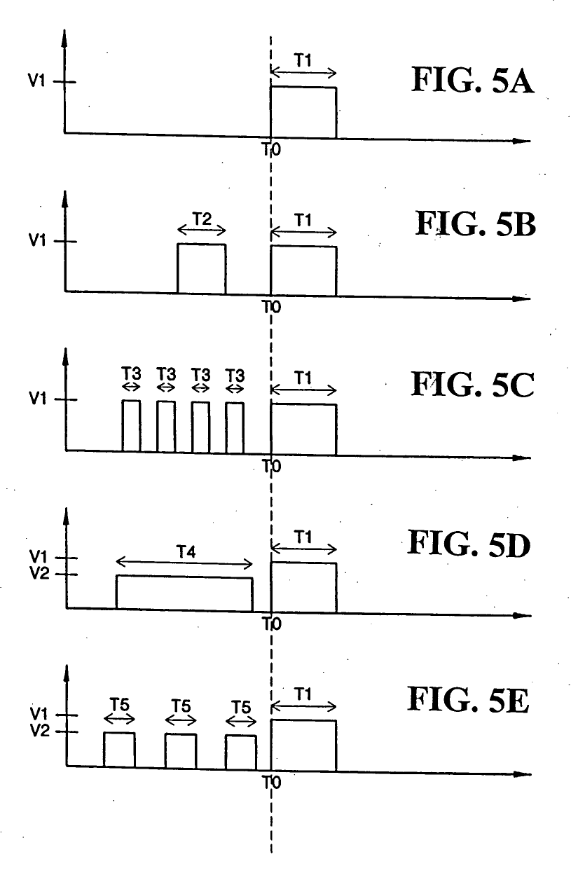

FIGS. 5A-5E illustrates the first drive signal and the second drive signal according to the embodiment of the present general inventive concept of the printer of FIG. 2.

In each graph of FIGS. 5A-5E, an X-axis represents time and a Y-axis represents voltages.

In addition, FIG. 5A represents the first drive signal including only the ejecting signal generated by the controller 1, and FIGS. 5B-5E represent the second drive signal including the preheating signal before the ejecting signal generated by the controller 1.

The first drive signal of FIG. 5A includes only the ejecting signal, and the ejecting signal having a first drive time T1 and a first voltage V1 is enabled after an ejecting time T0.

At the ejection time T0, multiplication of the first drive time and the voltage is represented as driving energy for ejecting the ink, and the first drive time T1 and the voltage V1 of the ejecting signal are determined as follows.

The heater 3c heats the ink for ejection when energy corresponding to the multiplication of a predetermined voltage and a predetermined time is applied, and the heated ink generates explosive bubbles. As a result, the ink is ejected onto a medium, such as a sheet of paper, through the nozzle. However, when the energy applied to the heater 3c becomes not less than a certain value, a bubble size of the ink as an ejecting drive force is the same as when the energy applied to the heater 3c is increased beyond that point. That is, it is not necessary to excessively use the energy for ejecting the ink because the bubble size may not increase, and therefore, the resulting dots may not be larger than at a lower preheating temperature.

Then, the controller 1 determines the time that the increase of the bubble size of the ink is saturated and ejection of the ink starts, by causing an ink ejection condition by applying a predetermined voltage to the heater 3c The voltage V1 and the first drive time T1 are determined, depending on the ink ejection condition.

Then, the second drive signal in FIGS. 5B-5E includes an ejecting signal enabled at the ejecting time T0 like the first drive signal in FIG. 5A, and further includes a preheating signal enabled before the ejecting time T0.

At this time, the driving energy by the preheating signal should be smaller than the ink ejecting energy. That is, the ink is ejected when the preheating signal driving energy is equal to or larger than the ink ejecting signal energy.

Since the driving energy is represented as the multiplication of the driving time and the voltage, the driving energy may be varied by the driving time and the voltage. Therefore, the controller 1 varies the driving time and the voltage of the preheating signal to generate the driving energy for preheating the ink.

First, the preheating signal of FIG. 5B having a first voltage V1 equal to the ejecting signal of FIG. 5A and a second driving time T2 smaller than the first driving time T1, and T2 occurring prior to T1, is enabled.

When the heater 3c heats the ink according to the preheating signal of FIG. 5B, the ink is not ejected so that the ink is preheated in the ink container 3b since the ink does not receive the energy enough to generate explosive bubbles needed for ejecting the ink onto the medium. The first voltage for T1 is thereafter applied, resulting in the ink ejecting after the ink is preheated.

The preheating signal of FIG. 5C having the first voltage V1 equal to the ejecting signal of FIG. 5A and multiple third driving times T3 each smaller than the second driving time T2, and also T1, is enabled .

In the case of the preheating signal of FIG. 5C, since the third driving times T3 of the respective preheating signals are very short, it is possible to apply the preheating signal and prevent the ink from being ejected prematurely before it receives the ejection signal.

In addition, a sum of the third driving times T3 of the preheating signals may become larger than the second driving time T2. That is, the temperature of the ink may be more increased to make the dot larger by preheating the ink at several intervals before ejecting it.

The preheating signals of FIGS. 5B and 5C have the first voltage V1 like the ejecting signal of FIG. 5A, and the driving time is adjusted to vary the driving energy to thereby preheat the ink.

The preheating signals of FIGS. 5D and 5E adjust both of the voltage and the driving time to vary the driving energy to thereby preheat the ink.

An operation of increasing an energy efficiency of the heater 3c will be described below.

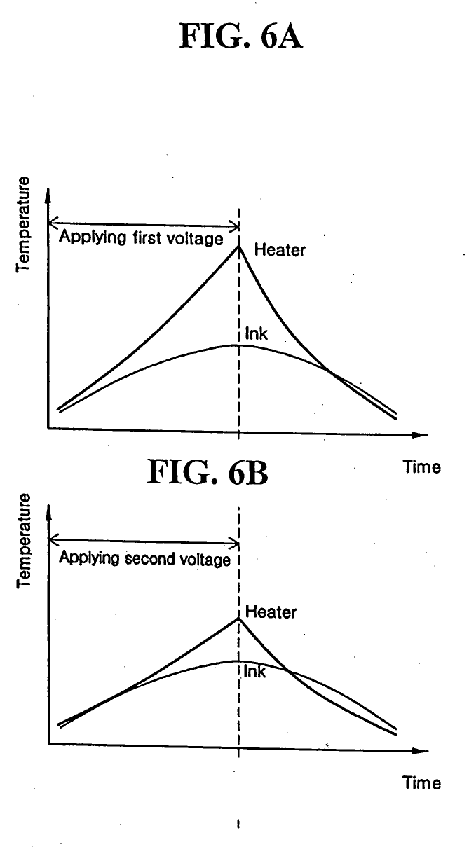

When a signal having the first voltage V1 is applied to the heater 3c for a predetermined time T2, the temperature of the heater 3c is rapidly increased as shown in FIG. 6A, but the temperature of the ink is smoothly increased. That is, the heater 3c consumes excessive energy instead of the energy being used to heat the ink, thereby lowering the energy efficiency.

On the other hand, when a signal having the second voltage V2 lower than the first voltage V1 is applied to the heater 3c for a predetermined time T2, the temperature of the heater 3c is increased similar to the temperature of the ink as shown in FIG. 6B. That is, the heater 3c does not consume the excessive energy and a greater portion of the inputted energy is used to heat the ink, thereby the energy efficiency.

As a result, the preheating signal in FIG. 5D having a fourth driving time T4 and the second voltage V2 lower than the first voltage V1 is enabled to increase the energy efficiency of the heater 3c.

In this process, the fourth driving time T4 is freely varied under the condition that the multiplication of the fourth driving time T4 and the second voltage V2, i.e., the driving energy for preheating the ink is smaller than the driving energy for ejecting the ink.

The preheating signal in of FIG. 5E having the second voltage V2 and a fifth driving times T5 smaller than the second driving time T2 is enabled , thereby making the dot larger as well as increasing the energy efficiency of the heater 3c.

Although FIGS. 5A-5E illustrate four embodiments of the drive signal for preheating the ink, these drive signals may be properly combined in various manners on the basis of the temperature and the preheating time of the ink, the energy efficiency of the heater, and so on.

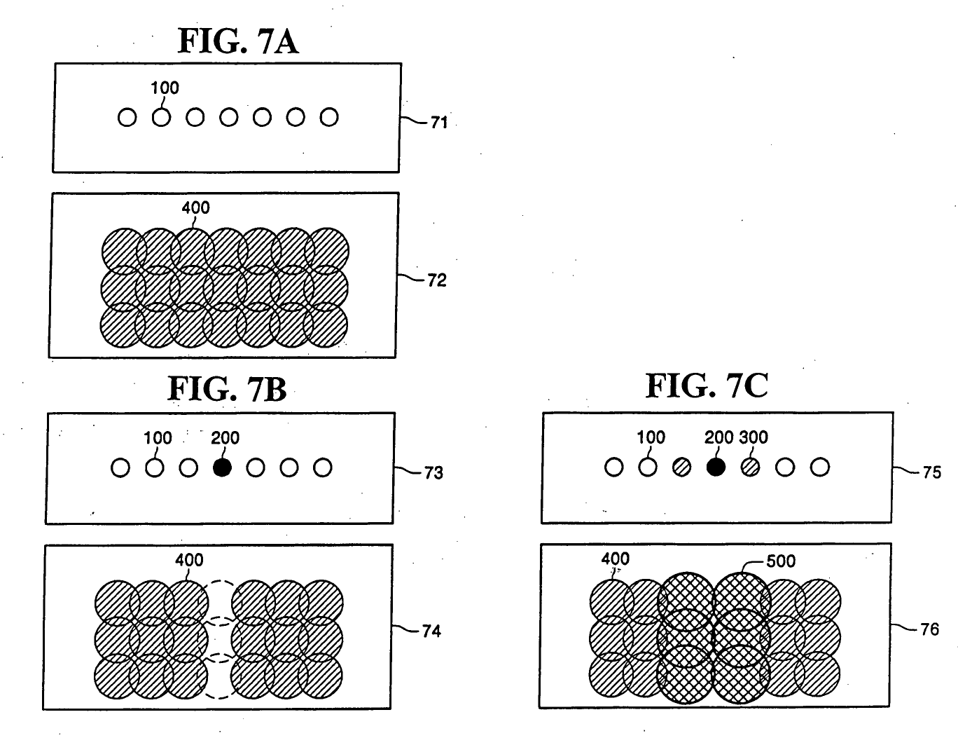

FIGS. 7A to 9 are views illustrating a method of determining adjacent nozzles according to an embodiment of the present general inventive concept and dots generated and printed on the medium according to the method of compensating a missing nozzle of a printer using the adjacent nozzles.

FIGS. 7A-7C are views illustrating dots generated depending on adjacent nozzles and the method of compensating the missing nozzle using the same according to an embodiment of the present general inventive concept

Nozzle arrays 71, 73 and 75 of FIGS. 7A-7C include nozzles disposed in a row, and dots having a single color are printed on media 72, 74 and 76 through the nozzles 100.

Nozzles 100 filled with white represent a normal nozzle, the nozzles 200 filled with black represent one or more missing nozzles, nozzles 300 filled with oblique lines represent adjacent nozzles, dots 400 filled with oblique lines represent dots generated by the ink ejected through the normal nozzles 100, and dots 500 filled with lattice lines represent dots generated by the ink ejected through the adjacent nozzles 300.

In the case that the image is printed in 100% coverage, i.e., all nozzles generate dots, as shown in FIG. 7A, when the nozzle array 71 includes only the normal nozzles, the medium 72 has a distribution of the dots 400 continuously generated in lateral and longitudinal directions.

However, as shown in FIG. 7B, when the nozzle array 73 includes the missing nozzle 200, the medium 74 has a continuous missing dot line by the missing nozzle 200, i.e., a continuous white line.

At this time, a missing dot region by the missing nozzle 200 has a size smaller than one pixel size depending on resolution of a printer as shown in the medium 74.

That is, the dot size is generally determined according to a margin for increasing an interval between nozzles and an optical density determined depending on a resolution provided by the nozzle arrays 71, 73 and 75 and a margin for compensating instrumental errors, and the dot size at this time is larger than the one pixel size.

For example, when the interval between the nozzles, i.e., the dot interval is 1200 dpi (dots per inch) depending on the resolution provided by the printer, the pixel size is 1 inch/1200 dots=21.2 μm, and the dot size is determined not less than 21.2 μm in consideration of a margin for increasing the optical density of the pixel size and a margin for compensating instrumental errors.

As a result, as shown in FIG. 7C, when the nozzle array 75 includes one missing nozzle 200, nozzles laterally adjacent to the missing nozzle 200 are determined as the adjacent nozzles 300. Then, when an operation of the missing nozzle 200 is required, the nozzle array 75 generates the dots 500 having a size increased through the adjacent nozzles 300.

Therefore, a missing dot region is compensated by the dots 500 generated through the adjacent nozzles 300, and the medium 76 has an image that the missing dot region is compensated.

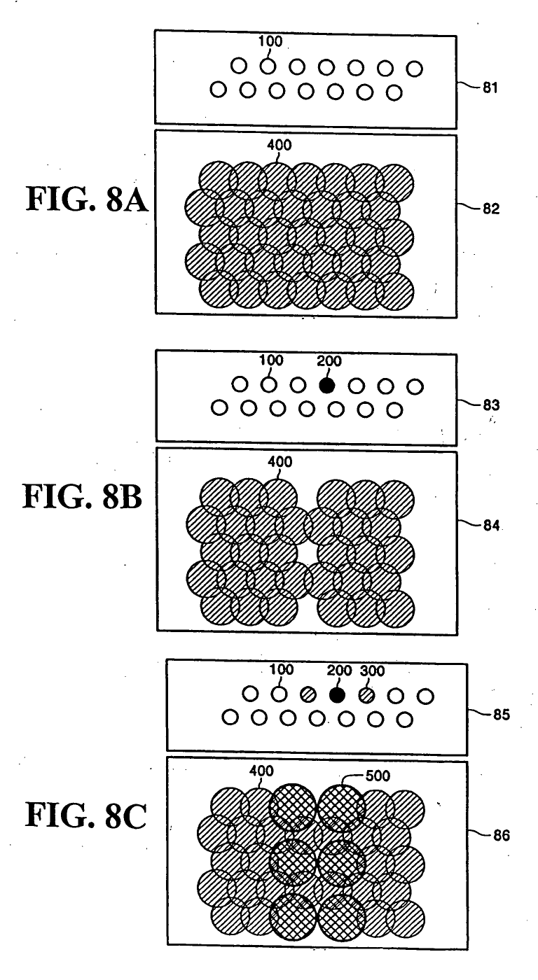

FIGS. 8A-8C are views illustrating dots generated and printed on depending on adjacent nozzles 300 and a method of compensating a missing nozzle 200 using the same according to an embodiment of the present general inventive concept.

Nozzle arrays 81, 83 and 85 of FIG. 8 include nozzles disposed in two rows, and dots having a single color are printed on media 82, 84 and 86 through the nozzles.

At this time, two nozzle rows of the nozzle arrays 81, 83 and 85 are alternately disposed. In order to decrease an interval between dots printed on the media without reducing a physical interval between the nozzles, that is, in order to increase image resolution without reducing the physical interval between the nozzles.

Nozzles 100 filled with white represent normal nozzles, nozzles 200 filled with black represent one or more missing nozzles, nozzles 300 filled with oblique lines represent adjacent nozzles, dots 400 filled with oblique lines represent dots generated by the ink ejected through the normal nozzles 100, and dots 500 filled with lattice lines represent dots generated by the ink ejected through the adjacent nozzles 300.

In the case that the image is printed in 100% coverage, i.e., all nozzles generate dots, as shown in FIG. 8A, when the nozzle array 81 includes only the normal nozzles 100, the medium 82 has a distribution of the dots 400 continuously generated in lateral and longitudinal directions.

However, as shown in FIG. 8B, when the nozzle array 83 includes one missing nozzle 200, the medium 84 has longitudinally intermittent missing dots.

In addition, as shown in FIG. 8C, when the nozzle array 85 includes one missing nozzle 200, nozzles located at the same row as the missing nozzle 200 and laterally adjacent to the missing nozzle 200 are determined as the adjacent nozzles 300.

When an operation of the missing nozzle 200 is required, the nozzle array 83 increases the dot size generated through the adjacent nozzles 300 corresponding to the missing nozzle 200.

As a result, the medium 86, at which the image was printed using the nozzle array 85, has an image that the missing dot region was compensated.

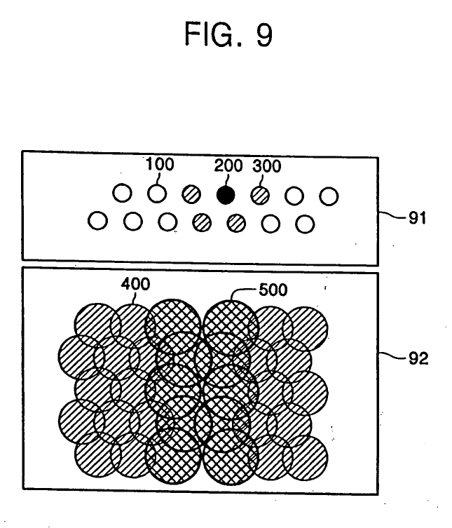

FIG. 9 is a view illustrating media dots generated depending on adjacent nozzles and a method of compensating a missing nozzle using the same in accordance with a third embodiment of the present invention.

A nozzle array 91 of FIG. 9 includes nozzles disposed in two rows as shown in FIG. 8, and dots having a single color are printed on a medium 92 through the nozzles.

In addition, when the missing nozzle 200 is generated as shown in FIG. 9, the nozzle array 91 determines nozzles 300 located at the same row as the missing nozzle 200 and laterally adjacent to the missing nozzle 200 and nozzles 300 located at a row different from the row of the missing nozzle 200 and most adjacent to the missing nozzle 200 as the adjacent nozzles. In addition, when an operation of the missing nozzle 200 is required, the nozzle array 91 increases the dot size generated through the adjacent nozzles 300 corresponding to the missing nozzle 200.

As a result, the medium 92, at which the image was printed using the nozzle array 91, has an image that a missing dot region was compensated with dots 400 and 500.

As can be seen from the foregoing, when each of the nozzle arrays includes the missing nozzle, the method of the present general inventive concept compensates the missing dot region due to the missing nozzle using the adjacent nozzles corresponding to the missing nozzle, thereby compensating operations of all color nozzles as well as the black nozzle.

The method of compensating a missing nozzle of a printer and the printer using the same is capable of compensating operations of all color nozzles as well as the black nozzle by compensating the missing dot region due to the missing nozzle using the adjacent nozzles corresponding to the missing nozzle. Therefore, the method of compensating the missing nozzle of the printer is capable of compensating operations of the missing nozzle when the image having a composite color is printed as well as when the black image is printed.

In addition, it is possible to always maintain appropriate image quality by compensating the operation of the missing nozzle through other adjacent nozzles even when a portion of the adjacent nozzles is out of order, since the number of the adjacent nozzles is larger.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

What is claimed is:

1. A method of compensating a missing nozzle of a printer, the method comprising:
determining adjacent nozzles corresponding to a missing nozzle; and
compensating the missing nozzle by generating one or more dots having an increased size through the adjacent nozzles and generating dots having a normal size through normal nozzles when the missing nozzle is generated in the nozzles performing a printing operation.

2. The method according to claim 1, wherein the compensating of the missing nozzle comprises:
applying a first drive signal to eject the ink to the other normal nozzles;
applying a second drive signal to preheat and to make the ink eject to the adjacent nozzles; and
ejecting the ink, after preheating the ink, depending on the second drive signal using the adjacent nozzles, and ejecting the ink depending on the first drive signal using the other normal nozzles.

3. The method according to claim 2, wherein the first drive signal applied to the other normal nozzles comprises:
an ejection signal to eject the ink.

4. The method according to claim 2, wherein the second drive signal applied to the adjacent nozzles comprises:
a preheating signal for preheating ink and an ejection signal to eject the ink.

5. The method according to claim 4, wherein the preheating signal has an energy less than that of the ejecting signal.

6. The method according to claim 5, wherein the ejecting signal is a pulse signal having a first voltage for a first time period.

7. The method according to claim 6, wherein the preheating signal is a pulse signal having a first voltage for a second time period smaller than a first time period.

8. The method according to claim 6, wherein the preheating signal is a plurality of pulse signals each having the first voltage for a third time period smaller than the first time period.

9. The method according to claim 6, wherein the preheating signal is a pulse signal having a voltage smaller than a first voltage for a fourth time period larger than a first time period; and the energy for the preheating signal for the fourth time period is less than the energy for the first time period.

10. The method according to claim 6, wherein the preheating signal is a plurality of pulse signals having a voltage smaller than a first voltage for a fifth period smaller than a first period.

11. The method according to claim 1, wherein the adjacent nozzles comprise nozzles located at the same row as the missing nozzle and laterally adjacent to the missing nozzle.

12. The method according to claim 1, wherein the adjacent nozzles comprise nozzles located at the same row as the missing nozzle and laterally adjacent to the missing nozzle, and nozzles located at a row adjacent to the row, at which the missing nozzle is located, and most adjacent to the missing nozzle.

13. The method according to claim 1, further comprising:
discriminating whether the missing dot is generated by scanning the dots after generating dots having a normal size through all nozzles included in the printer; and
obtaining nozzle information corresponding to the missing dot as the missing nozzle, and selecting nozzles adjacent to the missing nozzle as the adjacent nozzles when the missing dot exists.

14. The method according to claim 1, wherein the second size of the dot from the adjacent nozzles is larger than the first size of the dot from the other normal nozzles.

15. A method of compensating a missing nozzle of a printer, the method comprising:
determining normal nozzles of a plurality of nozzles and adjacent nozzles of the plurality of nozzles disposed adjacent to a missing nozzle of the plurality of nozzles, when the missing nozzle is generated in the nozzles during a printing operation;
storing information on the missing nozzle and the adjacent nozzles corresponding to the missing nozzle; and
applying a first drive signal to the normal nozzles to eject ink through the normal nozzles by heating the ink according to the first drive signal, and applying a second drive signal to the adjacent nozzles to eject the ink through the adjacent nozzles by preheating and heating the ink according to the second drive signal.

16. A method of compensating a missing nozzle of a printer, the method comprising:
determining a missing nozzle and normal nozzles among a plurality of nozzles;
determining one or more adjacent nozzles among the normal nozzles disposed adjacent to the missing nozzles; and
generating a first signal to the normal nozzles and a second signal to the adjacent nozzles, the first signal including a heating period signal to heat ink to be ejected through the normal nozzles, and the second signal including a preheating period signal and the heating period signal to preheat and heat the ink to be ejected through the adjacent nozzles.

17. The method according to claim 16, wherein the generating of the first signal and the second signal to the normal nozzles and the adjacent nozzles, respectively, comprises:
generating the first signal to normal heaters corresponding to the normal nozzles to heat the ink to be ejected through the normal nozzles; and
generating the second signal to adjacent heaters corresponding to the adjacent nozzles to preheat heat the ink to be ejected the adjacent nozzles.

18. The method according to claim 16, wherein the generating of the first signal and the second signal to the normal nozzles and the adjacent nozzles comprises:
generating the preheating signal to the adjacent nozzles to preheat the ink corresponds to the adjacent nozzles; and
generating the heating period signal to the normal nozzles and the adjacent nozzles to heat the ink corresponds to the normal nozzles and the adjacent nozzles to eject the ink through the normal nozzles and the adjacent nozzles.

19. The method according to claim 16, wherein the generating of the first signal and the second signal comprises:
generating the heating period signal having a first drive time and a first voltage; and
generating the preheating signal having a second drive time and a second voltage.

20. The method according to claim 19, wherein the preheating period signal comprises a plurality of multiple signals each having an interval there between.

21. The method according to claim 19, wherein the first drive time and the second drive time are different, and the first voltage and the second voltage are the same.

22. The method according to claim 19, wherein the first drive time and the second drive time are different, and the first voltage and the second voltage are different.

23. The method according to claim 16, wherein the ink corresponding to the normal nozzles has a first viscosity according to the first signal and the ink corresponding to the adjacent nozzles has a second viscosity lower than the first viscosity according to the second signal.

24. The method according to claim 16, wherein the generating of the first signal and the second signal comprises:
causing the ink corresponding to the normal nozzles to form first dots according to the first signal; and
causing the ink corresponding to the adjacent nozzle to form second dots larger than the first dots according to the second signal.

25. The method according to claim 16, wherein the plurality of nozzles comprise a first array of nozzles and a second array of nozzles, and the determining of the one or more adjacent nozzles comprises determining at least on of the first array of nozzles and at least one of the second array of nozzles as the adjacent nozzles.

26. The method according to claim 16, wherein the plurality of nozzles comprises first row nozzles and second row nozzles, the determining of the one or more adjacent nozzles comprises determining at least one of the first row nozzles disposed adjacent to the missing nozzle and at least one of the second row nozzles disposed closest to the missing nozzles when the missing nozzle is one of the first row nozzles.

27. A printer comprising:
a controller to apply a first drive signal to normal nozzles and a second drive signal to adjacent nozzles corresponding to a missing nozzle, when the missing nozzle is generated in the nozzles performing a printing operation;
a memory to store information on the missing nozzle and the adjacent nozzles corresponding to the missing nozzle; and
a plurality of nozzle arrays having nozzles and nozzle heaters to eject ink through the nozzle after preheating the ink when the nozzle heater receives the second drive signal, and to eject the ink through the nozzle without preheating the ink when the nozzle heater receives only the first drive signal.

28. The method according to claim 17, wherein the first drive signal comprises an ejection signal for ejecting the ink.

29. The method according to claim 17, wherein the second drive signal comprises a preheating signal for preheating ink and an ejection signal for ejecting the ink.

30. The printer according to claim 17, wherein the controller further comprises a function of determining nozzles located at the same row as the missing nozzle and laterally adjacent to the missing nozzle as the adjacent nozzles.

31. The printer according to claim 17, wherein the controller further comprises a function of determining nozzles located at the same row as the missing nozzle and laterally adjacent to the missing nozzle and nozzles located at a row adjacent to the row, at which the missing nozzle is located, and most adjacent to the missing nozzle as the adjacent nozzles.

32. A printer comprising:
a controller attached to a printing head with nozzle arrays that checks a print operation to determine missing nozzles and locates adjacent nozzles and applied preheating and ejection signals to said nozzles;
a plurality of nozzle arrays each containing a heater, an ink container and a nozzle that ejects normal size and larger size dots; and
a heater in each nozzle that heats and ink container in order to preheat ink of an adjacent nozzle to raise its temperature and the size of its ejected dots and to heat the container to create explosive bubbles to eject ink through the other normal nozzles and adjacent nozzles;

33. A printer comprising:
a plurality of nozzles and a plurality of heaters corresponding to the plurality of nozzles; and
a controller to determine a missing nozzle and normal nozzles among the plurality of nozzles, to determine one or more adjacent nozzles disposed adjacent to the missing nozzle from the normal nozzles, and to generate a first signal to the heaters corresponding to the normal nozzles and a second signal to the heaters corresponding to the adjacent nozzles, the first signal including a heating period signal to heat ink to be ejected through the normal nozzles, the second signal including a preheating period signal and the heating period signal to preheat and heat the ink to be ejected through the adjacent nozzles.
